(19) United States
(12) Patent Application Publication
(10) Pub. No.: US 2025/0319919 A1
(43) Pub. Date: Oct. 16, 2025

(54) CLEANING TROLLEY

(71) Applicant: Pfennig Reinigungstechnik GmbH, Durach (DE)

(72) Inventors: Dietmar PFENNIG, Sulzberg (DE); Kevin Maximilian BRÜSTLE, Sonthofen (DE)

(21) Appl. No.: 19/174,535

(22) Filed: Apr. 9, 2025

(30) Foreign Application Priority Data
Apr. 10, 2024 (DE) 10 2024 109 954.2

(51) Int. Cl. B62B 3/10; B62B 3/00; B62B 5/06

(52) U.S. Cl. CPC B62B 3/102; B62B 3/005; B62B 3/104; B62B 5/06; B62B 3/106; B62B 2202/50

(57) ABSTRACT

A cleaning system cart having a base module and attachment parts directly or indirectly arranged thereon. The attachment parts are individually selected from the group composed of casters, handles, mountings for containers and mountings for cleaning devices that the base module is realized in the form of a self-supporting, plate-like body and the plate-like body has fastening options for fastening the attachment parts.

### CROSS-REFERENCE TO RELATED APPLICATIONS

This patent application claims priority to German Patent Application No. DE 10 2024 109 954.2, filed on Apr. 10, 2024, the disclosure of which is incorporated by reference herein in its entirety as part of the present disclosure.

### FIELD

The present invention pertains to a cleaning system cart for commercial cleaning, particularly a cleaning system cart of the type used in different designs for hospital cleaning, maintenance cleaning and clean room cleaning.

### BACKGROUND

Such cleaning system carts are designed for simultaneously transporting fresh and used cleaning textiles, cleaning agents, metering devices, containers, mountings and devices for commercial cleaning such as mop cover holders. They usually have three working areas, namely a disposal area, a supply area and, if no pre-moistened mop covers are carried along, a moistening/metering area viewed from the rear toward the front in the driving direction of a cleaning cart.

Cleaning system carts of this type have a base module, on which casters and a handle for steering the cleaning system cart are fastened.

### SUMMARY

With respect to the above-described objects carried along on the base module, in particular, these cleaning system carts frequently are designed modularly such that they can be adapted to specific cleaning requirements and therefore to the environment to be cleaned by a user. This primarily concerns the type, number and attachment of cleaning utensils, cleaning liquids, storage containers for cleaning textiles, containers for receiving used cleaning textiles, waste and laundry bags and devices for commercial cleaning, which are chosen in dependence on the intended use. All components of these cleaning system carts can be adapted to different model types, arbitrarily expanded and retrofitted at any time—as needed for meeting the requirements of the respective object to be cleaned.

The base module of such a cleaning system cart has a welded tubular frame of stainless steel for applications in clean rooms and in the healthcare sector whereas the tubular frame of the base module is for other applications made of a plastic-aluminum combination or consists entirely of recycled plastic. Stainless steel sheets can be applied to this tubular frame.

In the first-mentioned field of application, the containers being carried along are likewise made of stainless steel or a plastic that can be autoclaved. The same applies to the aforementioned attachment parts such as casters, mountings of all types, container fixings and the like, which usually are made of bend and welded stainless steel wires, as well as covers made of stainless steel sheets. In other words, the base module of such a cleaning system cart is elaborately manufactured of high-quality and hygienically unproblematic materials because ergonomic handling and the hygienically safe use of the cleaning system cart are of significant importance, particularly for applications in clean rooms and hospitals.

Based on the circumstances, the invention aims to disclose a cleaning system cart that can be cost-efficiently manufactured while preserving the hygienic requirements.

This objective is attained with a cleaning system cart comprising a base module and attachment parts directly or indirectly arranged thereon, wherein said attachment parts are individually or in combination selected from the group composed of: casters, handles, mountings for containers and mountings for cleaning devices, wherein the base module is realized in the form of a self-supporting, plate-like body, and wherein the plate-like body has fastening options for fastening the attachment parts.

The welded tubular frame construction of the base module used so far is advantageously eliminated in the inventive cleaning system cart. The inventive replacement of the previous tubular frame with the inventive plate-shaped body—which, according to the invention, is furthermore provided in different designs for different superstructures—not only leads to a cost reduction in the manufacture, but also to a weight reduction and, in particular, a reduction of the shipping costs: due to the required welds of the base module, previous cleaning system carts were shipped from the manufacturer to the customer in a completely assembled manner such that a correspondingly large quantity of air had to be packaged and transported. As a result of the invention, more compact shipping can be achieved because the installation of the attachment parts on the base module can now be carried out at and/or by the customer. The attachment parts, particularly the casters and the handle, are screwed to the base module for this purpose.

The inventive plate-like body preferably is an actual plate, but may also be a body that has a stronger three-dimensionality than a plate, particularly due to cross braces or corrugations on its side that faces the bottom while the cleaning system cart is in use. In the first case, it is a flat body of constant thickness, which on two opposing sides is respectively delimited by a plane surface that is very extensive in relation to its thickness. Due to the material thickness and material type, as well as the construction, it is in any case constructed in a self-supporting manner and therefore has the corresponding stability for permanent use.

According to an embodiment of the invention, it is proposed that the plate-like body has upturns and/or that the mountings for containers are at least in part realized in the form of recesses. The upturns advantageously stabilize the plate-like body against twisting and bending and therefore allow the use of a thinner base plate, which in turn reduces the weight and makes it easier to transport and handle the cleaning system cart. In addition, these upturns also have the function of forming boundaries/stops for containers such that these containers can be moved around on the cleaning system cart in a slip-proof manner. The recesses once again reduce the weight and at the same time form a horizontal and a vertical guide for a container extending through these recesses while the cleaning system cart is in use.

These recesses and upturns, as well as the through-openings for connecting means provided in the plate-like body, are advantageously produced by means of cost-efficient punching and bending operations on the plate-like body. This allows the use of simple sheets of the desired size, which can also be correspondingly processed by means of progressive dies.

An individual adaptation to customer requirements is advantageously possible if the cleaning system cart has different self-supporting, plate-like bodies that can be interchanged, wherein the customer can select from a plurality of inventive plate-like bodies and thusly assemble cleaning carts that are individualized in accordance with the customer's specifications.

According to an enhancement of the invention, it is proposed that the plate-like body is formed of a material that can be punched and bent, particularly of a stainless steel or a passivated metal, or made of a fiber-reinforced composite. In the context of the invention, the term stainless steel refers, among other things, to unalloyed stainless steels and high-alloyed steels, especially high-alloyed steels that are suitable and authorized for use in clean rooms of any type and particularly are non-corroding, e.g. V2A and V4A steels. The term passivated metal refers to all metals, the surface of which was modified in such a way that oxygen corrosion of the base material is prevented or at least significantly slowed down. This modification can also be realized by means of anodizing. The material preferably can also be repeatedly autoclaved without deterioration of quality and therefore is suitable for use in clean rooms.

According to an enhancement of the invention, it is proposed that one attachment part, particularly the attachment part carrying a handle, is realized in the form of a tubular frame. This attachment part, which is aligned vertically while the cleaning system cart is in use, usually not only carries a handle, but also mountings for containers, particularly also for disposal containers, and for cleaning devices such as mop holders. The use of a tubular frame, which is screwed to the self-supporting stainless steel plate, reduces the weight of the cleaning system cart and provides corresponding fastening options for the aforementioned additional objects. This tubular frame preferably is composed of stainless steel tubes, particularly welded stainless steel tubes.

According to an embodiment of the invention, it is proposed that a seal is arranged between the plate-like body and an attachment part. This seal provides improved hygiene because it closes gaps, in which germs or dust particles could otherwise be deposited. This seal preferably is a plastic seal, particularly of plastics that are suitable for use in clean rooms and/or can be autoclaved, but may in another embodiment also be a metal seal.

This seal may also be realized in a chamfered manner in order to always ensure its defined contact with the seal seats.

### BRIEF DESCRIPTION OF THE DRAWINGS

The invention is described in greater detail below with reference to the drawings, in which identical components are identified by the same reference symbols. In these drawings:

FIG. 1 shows a perspective view of an inventive cleaning system cart,

FIG. 2 shows a bottom view of an inventive cleaning system cart,

FIG. 3 shows an exploded view and

FIG. 4 shows a detailed view of a seal.

### BRIEF DESCRIPTION OF THE DRAWINGS

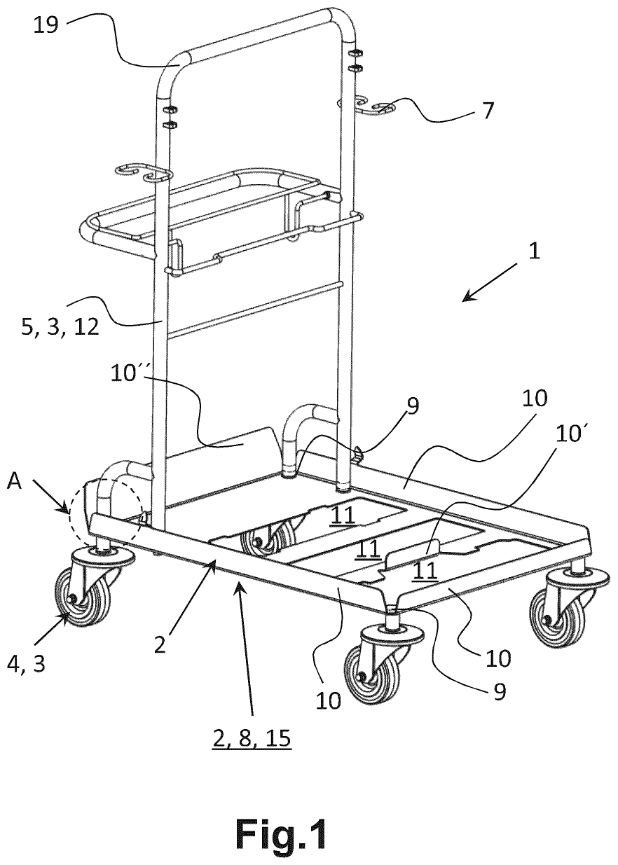

FIG. 1 shows a perspective view of an inventive cleaning system cart 1. The self-supporting, plate-like body 8 is a stainless steel sheet in this embodiment. However, it may also be formed of another above-described material such as a fiber-reinforced composite or a passivated metal as long as it remains suitable for use in clean rooms and can be autoclaved without deterioration of quality. This figure initially shows the approximately rectangular basic shape of this stainless steel sheet 8, which forms the inventive base module 2. The stainless steel sheet 8 has upturns 10, which particularly are arranged marginally, and punch-outs 11 in the surface area 15 of the stainless steel sheet 8, which are spaced apart from one another in the corner regions, form mountings for containers that at least partially extend through these punch-outs 11 while the cleaning system cart is in use and are thereby guided horizontally, as well as vertically. Fastening means located on the underside of the base module 2 on its four corners make it possible to fasten, particularly screw, the casters 4 to the base module 2. These casters 4 belong to the attachment parts 3 that are installed on the base module 2.

An upturn 10″ that is realized higher than the other three marginal upturns 10 is located in the rear region of the base module 2. In this way, a container for used cleaning textiles located in this region of the cleaning system cart can also be advantageously supported and guided in its bottom region. Containers of this type frequently consist of plastic bags and therefore are correspondingly foldable/flexible.

An upturn 10′ in the surface area 15 likewise serves as a guide for a container. The surface shape of the punch-outs 10 is advantageously adapted to the respective shape of the container to be accommodated, wherein said punch-outs may simply be rectangular or realized with complicated shapes.

The handle 5 is realized in the form of a welded tubular frame 12 of stainless steel and protrudes vertically beyond the base module 2. In this context, the term handle 5 refers to the entire attachment part 3, but the actual handle region 19 is located on the top of this attachment part. This attachment part 3 carries another attachment part in the sense of the invention, namely the mounting 7 for a mop holder, i.e. a cleaning device. It likewise provides fastening options 9 for other utensils required for the cleaning process.

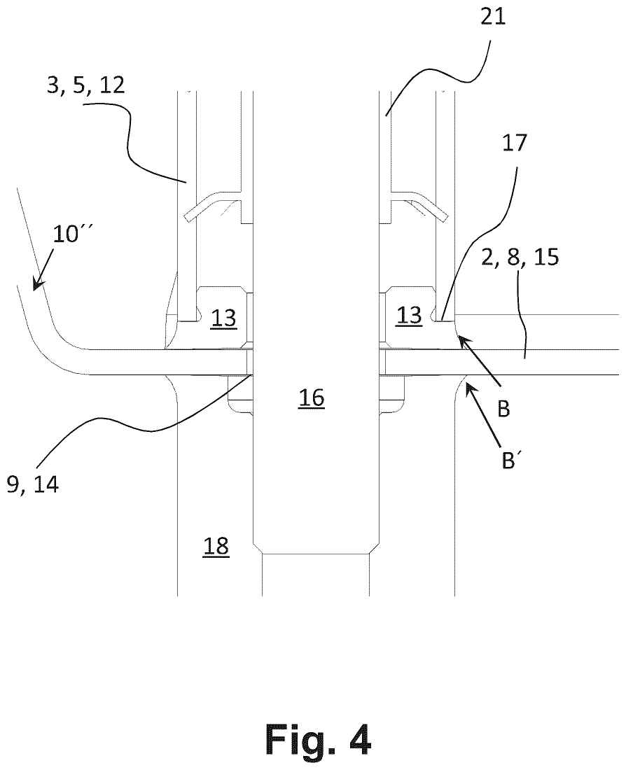

A region identified by the letter A indicates the region illustrated in the form of a section in FIG. 4.

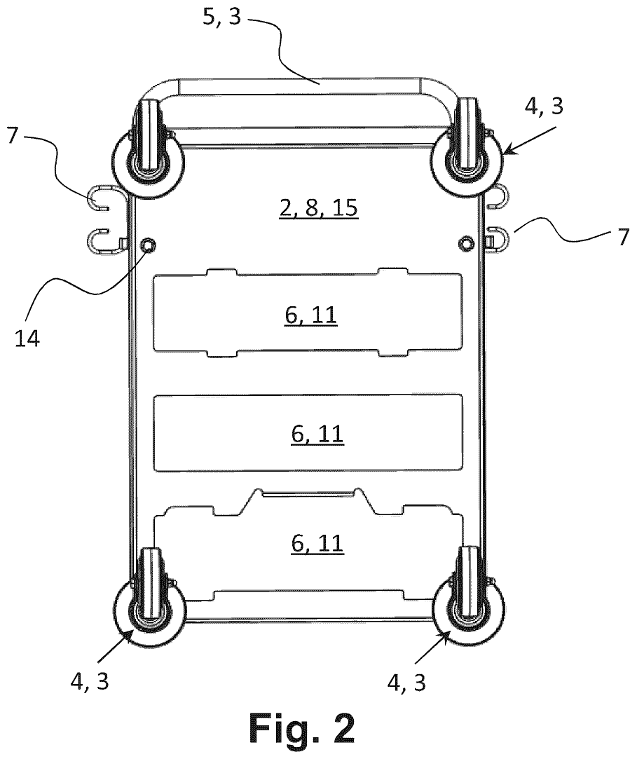

FIG. 2 shows a bottom view of an inventive cleaning system cart 1.

This figure shows four casters 4 that are fastened in the corners of the base module 2. Two of the four through-openings 14, which serve for fastening the attachment part “handle” 3, 5 on the base module 2 and through which fastening means extend, are visible in this figure whereas the other two through-openings are respectively covered by a caster 4. The punch-outs 11 for holding/guiding containers, particularly with fresh cleaning textiles, cleaning liquids and the like, are clearly visible in this figure.

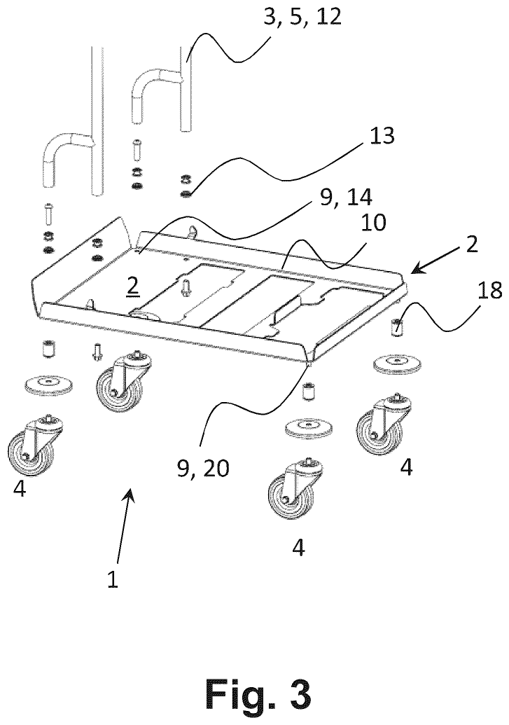

FIG. 3 shows an exploded view of a portion of the embodiment of the cleaning system cart 1. The attachment part 3 “handle” 5 in the form of a tubular frame 12, as well as the casters 4, are fastened on the same base module 2 as in FIGS. 1 and 2. This figure shows fastening options 9 in the base module 2, which are respectively realized in the form of through-openings 14 and, in particular, (threaded) bolts 20 welded to the front end of the cleaning system cart 1.

This illustration clearly shows the ease of transport of the inventive cleaning system cart, which is advantageously achieved due to the simple constructive design according to the invention, wherein this cleaning system cart essentially consists of the two flat components base module 2 and handle 5, as well as other, significantly smaller attachment parts 3 that can be accommodated in a transport package in a space-saving manner.

FIG. 4 shows a detailed view of an approximately disc-shaped seal 13 in its installation position on an attachment part 3 in the form of a caster 4 underneath the surface area 15 and the attachment part “handle” 3, 5 above this surface area. The surface area 15 has a through-opening 14, through which a fastening means 16 extends, wherein said fastening means is in this embodiment realized in the form of a threaded bolt at this location of the cleaning cart. According to an enhancement of the invention, the fastening means 16 at this location or another location may also be a star grip nut, a stud bolt or the like fastened on the plate-like body 8.

This seal 13 preferably is made of stainless steel and has an angle B with contact surfaces 17 such that a secure seal is achieved between the assemblies on the outer side, wherein this secure seal prevents the admission of liquid into the gap and therefore improves the inventive cart hygienically. An angle B′, which is respectively arranged on the caster 4 or its spacer and connection piece 18, is also provided for this purpose. In this case, the threaded bolt 16 is screwed to the connection piece 18 and a sleeve 21 with an internal thread, wherein said sleeve engages into the tubular frame 12 such that the caster 4 and the tubular frame 12 are tensioned against the base module 2.

The inventive design of the base module 2 in the form of a stainless steel sheet 8 advantageously makes it possible to realize a cleaning system cart that is suitable for use in clean rooms, has a simple constructive design, can be easily transported, as well as modularly adapted to customer requirements.

### LIST OF REFERENCE SYMBOLS

1 Cleaning system cart
2 Base module
3 Attachment part
4 Caster
5 Handle
6 Mounting for containers
7 Mounting for cleaning devices
8 Self-supporting, plate-like body
9 Fastening option
10 Upturn
11 Recess
12 Tubular frame
13 Seal
14 Through-opening for connecting means
15 Surface area
16 Fastening means
17 Contact surface
18 Spacer
19 Handle region
20 Bolt
21 Sleeve

What is claimed is:

1. A cleaning system cart (1) comprising:
a base module (2), and
attachment parts (3) directly or indirectly arranged thereon, wherein said attachment parts are individually or in combination selected from the group composed of:
casters (4),
handles (5),
mountings (6) for containers, and
mountings (7) for cleaning devices,
wherein the base module (2) is realized in the form of a self-supporting, plate-like body (8), and
wherein the plate-like body (8) has fastening options (9) for fastening the attachment parts (3).

2. The cleaning system cart (1) according to claim 1, wherein the plate-like body (8) has upturns (10) and/or in that the mountings (6) for containers are at least in part realized in the form of recesses (11).

3. The cleaning system cart (1) according to claim 1, wherein the different plate-like bodies (8) can be interchanged.

4. The cleaning system cart (1) according to claim 1, wherein the plate-like body (8) is formed of a material that can be punched and bent, particularly of a stainless steel, a passivated metal or a fiber-reinforced composite.

5. The cleaning system cart (1) according to claim 1, wherein one attachment part (3), particularly the attachment part (3) carrying a handle (5), is realized in the form of a tubular frame (12).

6. The cleaning system cart (1) according to claim 1, wherein it has a seal (13) between the plate-like body (8) and an attachment part (3).

7. The cleaning system cart (1) according to claim 1, wherein the seal (13) is realized in a chamfered manner and/or has a contact surface (17).
